(19) United States
(12) Patent Application Publication
(10) Pub. No.: US 2010/0189627 A1
(43) Pub. Date: Jul. 29, 2010

(54) CARBONIZATION APPARATUS AND METHOD OF THE SAME

(76) Inventors: Chung-Hua Hu, Taichung City (TW); Kuo-Ting Lee, Taoyuan County (TW)

Correspondence Address: Muncy, Geissler, Olds & Lowe, PLLC, 4000 Legato Road, Suite 310, FAIRFAX, VA, 22033, US

(21) Appl. No.: 12/360,414

(22) Filed: Jan. 27, 2009

(51) Int. Cl. C01B 31/02; B01J 19/00

(52) U.S. Cl. 423/445 R; 422/211

(57) ABSTRACT

A continuous negative pressure carbonization apparatus includes a material feeding device, a carbonizing chamber and a material collecting device. The material feeding device feeds the raw material. The carbonizing chamber receives and carbonizes the raw material and it includes a carbonization device and two buffering devices. The carbonization device has a carbonization chamber. The carbonization chamber has a material inlet and a material outlet. The buffering devices are respectively mounted and connected to the material inlet and the material outlet. The material collecting device collects the carbonized product from the carbonization chamber. When the raw material is carbonized in the carbonization chamber, the pressure of the carbonization chamber is kept at a negative pressure state smaller than the atmospheric pressure.

### BACKGROUND

1. Field of Invention

The present invention relates to a continuous negative pressure carbonization apparatus and the method of the same, and particularly relates to a continuous carbonization apparatus that executes the carbonization process in the negative pressure condition and method thereof.

2. Description of Related Art

The application of the carbonization apparatus is very popular in applications such as the production of woven carbon fiber fabric. The continuous carbonization apparatus and the prior method heats the carbonization chamber and infuse a large volume of inert gas, such as nitrogen (N2), which will not react with the material. Therefore, when the raw material, fabric, is carbonized in the carbonization chamber, the inert gas prevents the raw material from touching and reacting with the oxygen in the air. And then, the non-carbon elements of the raw material are removed in the high temperature carbonization process. Finally, the raw material is carbonized into the carbon product.

As mentioned above, since a lot of inert gas is infused into the carbonization chamber, the pressure of the carbonization chamber is larger than the atmospheric pressure outside the carbonization chamber, i.e. the carbonization chamber is kept at a positive pressure.

However, when the carbonization chamber is kept at a positive pressure, the non-carbon elements are difficult to remove and the by-product gas fills the carbonization chamber. The ash and the tar also increases but the degree of carbonization decreases because non-carbon elements are hard to remove from the raw material under the positive pressure and the un-removed non-carbon elements effects the rearrangement of the carbon layer.

Therefore, a better carbonization apparatus and method is pursued to solve the drawback mentioned above.

### SUMMARY

One objective of the present invention is to provide a continuous carbonization apparatus and method for carbonizing the raw material under the negative pressure. In other words, the pressure of the carbonization chamber is lower than the atmospheric pressure.

According to the objective of the present invention, the continuous negative pressure carbonization apparatus includes a material feeding device, a carbonizing chamber and a material collecting device. The material feeding device feeds the raw material. The carbonizing chamber receives and carbonizes the raw material.

The carbonizing chamber includes a carbonization device and two buffering devices. The carbonization device has a carbonization chamber. The carbonization chamber has a material inlet and a material outlet. The buffering devices are respectively mounted and connected to the material inlet and the material outlet. The material collecting device collects the carbonized product from the carbonization chamber. When the raw material is carbonized in the carbonization chamber, the pressure of the carbonization chamber is kept at a negative pressure state smaller than the atmospheric pressure.

According to the objective of the present invention, the continuous negative pressure carbonization method includes the steps as following: First, continuously providing raw material. Second, carbonizing the raw material in a carbonization chamber, the pressure of the carbonization chamber is kept at a negative pressure state with the chamber pressure being lower than the atmospheric pressure while the raw material is carbonized in the carbonization chamber.

The advantages of the present invention is that:

When the raw material is carbonized in the carbonization chamber, the by-product gas can be removed easily. Therefore, the structure of the carbon layer in the carbon product is much regular than the prior. In other words, the degree of the carbonization is increased.

Besides, the ash inside the carbonization chamber is fewer. And therefore, the unexpected reaction between the by-product gas and the raw material is decreased. In other words, the degree of the carbonization of the carbon product is increased.

At least, since the present invention doesn't need lots of nitrogen and the buffering devices prevent the oxygen come from outside to affect the process, the thermal consumption and the inert gas consumption are also decreased.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is the schematic view of the continuous negative pressure carbonization apparatus of the first embodiment of the present invention.

FIG. 2 is the schematic view of the continuous negative pressure carbonization apparatus of the second embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The continuous negative pressure carbonization apparatus and method of the present invention provides a negative pressure state to the carbonization chamber of the carbonization device. And therefore, the raw material is carbonized in a negative pressure state. The application of the present invention is not limited to producing the woven carbon fabric fiber, and is able to be applied in any continuous carbonization process. To describe the present invention clearly, the embodiments take the woven fiber fabric for instance.

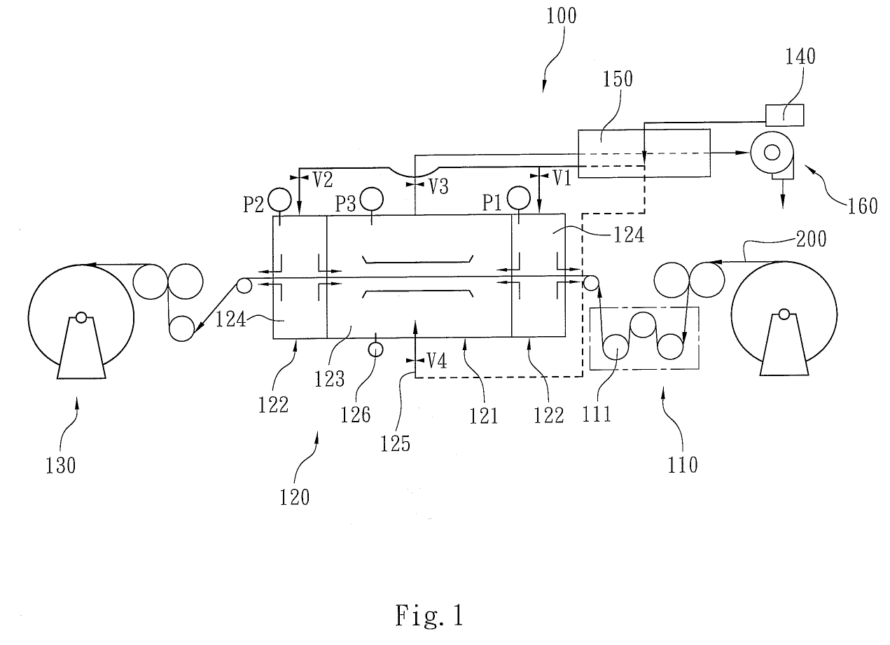

Please refer to FIG. 1 for the first embodiment of the present invention. The carbonization apparatus 100 includes a material feeding device 110, a carbonizing chamber 120, a material collecting device 130, a gas providing device 140, a thermal exchanger 150 and a pumping device 160. The material feeding device 110 includes several rollers 111. The rollers 111 feed raw material 200 into the chamber and control the tension of the raw material 200. In this embodiment, the raw material 200 is preferably a woven fiber fabric.

The raw material 200 is carbonized into a woven carbon fiber fabric via the carbonizing chamber 120. And the carbon product, woven carbon fiber fabric, is further collected by the material collecting device 130.

The carbonizing chamber 120 includes a carbonization device 121 and several buffering chambers 122. The buffering chambers 122 are mounted and connected to the material inlet and the material outlet respectively. In the embodiment, the carbonization device 121 includes a carbonization chamber 123. The buffering devices 122 are able to be the inlet buffering chambers or the outlet buffering chambers 124. Further more, each of the buffering chambers 122 includes several inlet buffering chambers or several outlet buffering chambers 124 if necessary. The carbonization device 121 further includes an air purge inlet 125. The air purge inlet 125 connects the carbonization chamber 123 to purge the carbonization chamber 123.

The gas providing device 140 connects to the buffering chambers 122 and the carbonization chamber 123 separately, and further provides the inert gas, such as the nitrogen, to the buffering chambers 122 and the carbonization chamber 123. The gas providing device 140 includes several control valves, such as the control valves V1 and V2 drafted in FIG. 1. The control valves coordinate with the pressure meters, such as the pressure meters P1 and P2 drafted in FIG. 1, are able to control the flow rate injected in the buffering chambers 122. Therefore, the buffering chambers 122 are kept at a positive pressure state compared with the carbonization chamber 123. The gas providing device 140 further includes a control valve, such as the control valve V4 drafted in FIG. 1, to coordinate with the oxygen gas meter 126 to control the inert gas purge flow rate injected in the carbonization chamber 123.

The pumping device 160 connects the carbonization chamber 123 to pump out the by-product gas. The pumping device 160 includes a control valve, such as the control valve V3 drafted in FIG. 1, to coordinate with the pressure meter, such as the pressure meter P3 drafted in FIG. 1, to control the flow rate of the by-product gas pumped out from the carbonization chamber 123. And therefore, in sure that the carbonization chamber 123 is kept at the negative pressure state compared with the inlet buffering chambers or the outlet buffering chambers 124.

The embodiment further includes a means for using the thermal of the pumped gas to heat the inert gas comes from the gas providing device 140. For instance, the means mentioned above is preferred to be a thermal exchanger 150. The thermal exchanger 150 heats the inert gas from the gas providing device 140 with the pumped gas which is extracted from the carbonizing chamber 120 by the pumping device 160.

In the embodiment, the pressure of the buffering chambers 124 is kept at about 760 Torr, i.e. one atmospheric pressure. But the pressure of the carbonization chamber 123 is kept from 1 Torr to less than 760 Torr. In other words, the pressure of the carbonization chamber 123 is smaller than one atmospheric pressure, i.e. P2 or P1>1 atm>P3. The inert gas, such as the nitrogen, is injected into the carbonization chamber 123 via the air purge inlet 125 to reduce the oxygen concentration of the carbonization chamber 123 before feeding the raw material 200 into the carbonization chamber 123.

When the carbonization process is executed, the pressure of the carbonization chamber 123 is kept at the negative pressure state. Besides, an oxygen gas meter 126 can be set with the carbonization chamber 123 to detect the oxygen concentration of the carbonization chamber 123. Therefore, once the oxygen concentration of the carbonization chamber 123 is larger than a preset value, the air purge function is triggered to purge the carbonization chamber 123 by the inert gas, such as the nitrogen, via the air purge inlet 125 to reduce the oxygen concentration of the carbonization chamber 123. In conclusion, the oxygen concentration of the carbonization chamber 123 is maintained in the scope of 1 ppm-10%.

Besides, the heating time period for carbonizing the raw material 200 into the carbon product inside the carbonization chamber 123 is set in the scope from one minute to thirty minutes. The tension of the raw material 200 can be increased or decreased by the rollers 111 to control the contraction rate and prevent damaging the carbon product. The process temperature of the carbonization chamber 123 is set from 500° C. to 1200° C.

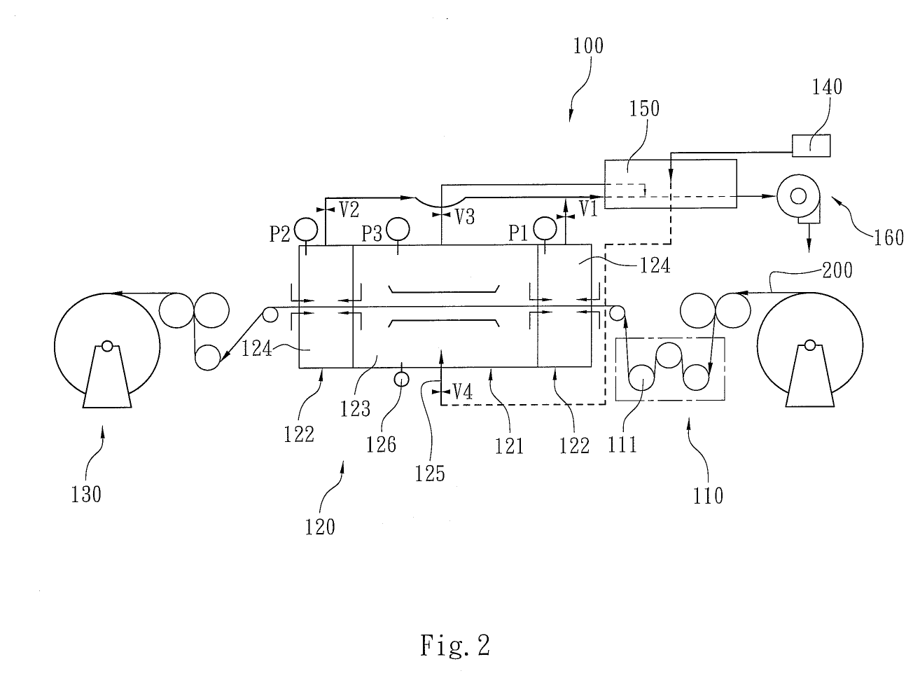

Please refer to FIG. 2 for a carbonization apparatus of the second embodiment of the present invention. The characteristics of the second embodiment is similar to the first embodiment, and the difference between them is that:

The gas providing device 140 connects to the carbonization chamber 123 to provide the inert gas, such as nitrogen. The gas providing device 140 includes a control valve, such as the control valve V4 drafted in FIG. 2, to coordinate with the oxygen gas meter 126 to control the inert gas flow rate injected into the carbonization chamber 123 via the air purge inlet 125.

The pumping device 160 connects the buffering chambers 122 and the carbonization chamber 123 respectively for pumping out the air inside themselves. The pumping device 160 includes several valves, such as the valves V1, V2 and V3 drafted in FIG. 2, to coordinate with several pressure meters, such as the pressure meters P1, P2 and P3 drafted in FIG. 2, to control the flow rates of pumping out the buffering chambers 122 and the carbonization chamber 123. And therefore, the pressures of the buffering chambers 122 and the carbonization chamber 123 are kept in the negative pressure state compared with the atmospheric pressure.

In the embodiment, the pressure of the carbonization chamber 123 is larger than that of the buffering chambers 124, i.e. 1 atm>P3>(P1 or P2). Therefore, the by-product gas of the carbonization chamber 123 flows to the buffering chambers 122 and further be pumped out by the pumping device 160. The pressure of the carbonization chamber 123 is kept in the scope 1-760 Torr, i.e. smaller than one atmospheric pressure.

When the carbonization process is executed, the pressure of the carbonization chamber 123 is kept at the negative pressure state. An oxygen gas meter 126 can be set with the carbonization chamber 123 to detect the oxygen concentration of the carbonization chamber 123. Therefore, once the oxygen concentration of the carbonization chamber 123 is larger than a preset value, the air purge function is triggered to purge the carbonization chamber 123 by the inert gas, such as the nitrogen, via the air purge inlet 125 to reduce the oxygen concentration of the carbonization chamber 123. In conclusion, the oxygen concentration of the carbonization chamber 123 is maintained in the scope of 1 ppm-10%, i.e. 1 ppm-100 kppm.

When using the PolyAcryloNitrile (PAN) fiber fabric to be the raw material, and applying the process condition provided by the first embodiment to be the experimental group and further applying the prior condition to be the reference group to produce the carbon fiber fabric, the comparison is as following:

The process condition of the reference group (take the production of a 50m carbon fabric fiber for instance):

Temperature: 1000° C.;

Heating time period: 10 minutes;

Tension: 3.0-4.0 kg;

The pressure of the carbonization chamber 123: larger than 760 Torr (N2 are filled into the carbonization chamber for protection);

Used power: 110-115 KW/hr; and

Total weight of nitrogen (N2): 188 kg.

The process condition of the experimental group (take the production of a 50 m carbon fabric fiber for instance):

Temperature: 1000° C.;

Heating time period: 10 minutes;

Tension: 3.0-4.0 kg;

The pressure of the carbonization chamber 123: smaller than 760 Torr (about 450-500 Torr);

Used power: 95-100 KW/hr; and

Total weight of nitrogen (N2): 105 kg.

The carbon fabric fibers produced by the conditions mentioned above are analyzed as following:

| Terms | | Reference group | Experimental Group |
|---|---|---|---|
| Carbon layer | nm | 145.1 | 155.8 |
| stack | | | |
| thickness | | | |
| Lc | | | |
| Carbon layer | nm | 0.8028 | 1.3302 |
| stack length | | | |
| La | | | |
| Density | g/cm³ | 1.8011 | 1.7784 |
| Element | C % | 89.975 | 92.03 |
| analysis | N % | 7.635 | 6.205 |
| | H % | 0.71 | 0.95 |
| | O % | 1.68 | 0.815 |
| Surface | Ω/cm² | 0.9132 | 0.6523 |
| Resistance | | | |
| Ash | % | 0.86 | 0.12 |

According to the table listed above, the negative pressure carbonization method of the present invention is able to reduce the 13.4% usage of power and the 44.1% usage of Nitrogen. When analyzing the microstructure of the carbon fabric fiber, the method of the present invention includes the advantages as following:

The carbon layer stack thickness (Lc) increased about 7.4%, the carbon layer stack length (La) increased about 65.7%, and the carbon concentration increased about 2.28%. In other words, the method of the present invention is lo able to increase the degree of carbonization when using the same temperature with the prior.

The surface resistance of the carbon fabric fiber produced by the method of the present invention reduced about 28.6% than prior. It's an index to prove that the degree of carbonization is increased by the method of the present invention.

The ash in the embodiment decreased about 86%, and it means that the continuous negative pressure carbonization method of the present invention is able to remove the by-product gas and therefore decrease the ash.

While the present invention has been described by way of example and in terms of a preferred embodiment, it is to be understood that the present invention is not limited thereto. To the contrary, it is intended to cover various modifications and similar arrangements and procedures, and the scope of the appended claims therefore should be accorded the broadest interpretation so as to encompass all such modifications and similar arrangements and procedures.

Although the present invention has been described in considerable detail with reference t certain embodiments thereof, other embodiments are possible. Therefore, their spirit and scope of the appended claims should no be limited to the description of the embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A carbonization apparatus comprising:
means to provide a raw material;
a carbonizing chamber for carbonizing the raw material into a carbon product;
means for collecting the carbon product; and
means for maintaining the carbonizing chamber at a working pressure lower than atmospheric pressure when the raw material is carbonized into the carbon product.

2. The carbonization apparatus of claim 1, further comprising:
at least one inlet buffering chamber connected to the inlet of the carbonizing chamber; and
at least one outlet buffering chamber connected to the outlet of the carbonizing chamber.

3. The carbonization apparatus of claim 2, wherein the means for maintaining the carbonizing chamber at the working pressure comprises:
means for supplying inert gas into the carbonizing chamber, the inlet buffering chamber, and the outlet buffering chamber; and
means for pumping gas out of the carbonizing chamber.

4. The carbonization apparatus of claim 3, further comprising:
means for heating the inert gas by heat from the gas pumped out of the carbonizing chamber.

5. The carbonization apparatus of claim 2, wherein the means for maintaining the carbonizing chamber at the working pressure comprises:
means for supplying inert gas into the carbonizing chamber; and
means for pumping gas out of the carbonizing chamber, the inlet buffering chamber, and the outlet buffering chamber.

6. The carbonization apparatus of claim 5, further comprising:
means for heating the inert gas by heat from the gas pumped out of the carbonizing chamber, the inlet buffering chamber, and the outlet buffering chamber.

7. The carbonization apparatus of claim 1, further comprising:
a plurality of inlet buffering chambers connected to the inlet of the carbonizing chamber; and
a plurality of outlet buffering chambers connected to the outlet of the carbonizing chamber.

8. The carbonization apparatus of claim 1, wherein the carbonizing chamber comprises an air purge inlet.

9. The carbonization apparatus of claim 1, wherein the carbonizing chamber comprises an oxygen gas meter.

10. A carbonization method comprising:
providing a continuous raw material;
carbonizing the continuous raw material by a carbonizing chamber; and
maintaining the carbonizing chamber at a working pressure lower than atmospheric pressure when the continuous raw material is carbonized.

11. The carbonization method of claim 10, further comprising:
purging the carbonizing chamber of oxygen before the continuous raw material is carbonized.

12. The carbonization method of claim 10, wherein the carbonizing chamber has an oxygen concentration of 1 ppm-100 kppm.

13. The carbonization method of claim 10, wherein the carbonizing chamber is at a temperature of 500° C.-1200° C.

14. The carbonization method of claim 10, wherein the carbonizing step comprises:
lo heating the continuous raw material in the carbonizing chamber for 1 min˜25 min.
